(19) United States
(12) Patent Application Publication
(10) Pub. No.: US 2025/0284061 A1
(43) Pub. Date: Sep. 11, 2025

(54) VOLUME HOLOGRAPHIC OPTICAL WAVEGUIDE ELEMENT FOR MIXED REALITY NEAR-EYE DISPLAY

(71) Applicant: National Central University, Taoyuan City (TW)

(72) Inventors: Ching-Cherng Sun, Taoyuan City (TW); Shiuan-Huei Lin, HsinChu City (TW); Wei-Chia Su, Changhua City (TW); Yeh-Wei Yu, Taoyuan City (TW); Tsung-Hsun Yang, Taoyuan City (TW); Zih-Fan Chen, HsinChu City (TW); Wen-Kai Lin, Taoyuan City (TW)

(21) Appl. No.: 18/636,025

(22) Filed: Apr. 15, 2024

(30) Foreign Application Priority Data
Mar. 8, 2024 (TW) 113108671

(51) Int. Cl. G02B 6/26; G02B 27/01

(52) U.S. Cl. CPC G02B 6/262; G02B 27/0172; G02B 2027/0174

(57) ABSTRACT

The present invention provides a volumetric holographic optical waveguide element for a mixed reality near-eye display, comprising: a waveguide plate; a coupling-in element group, which includes a coupling-in volume holographic optical element and a coupling-in refractive/reflective element disposed on both corresponding sides of the waveguide plate, respectively; an coupling-out element group, which includes an coupling-out volume holographic optical element and a coupling-out refractive element disposed on both corresponding sides of the waveguide plate, respectively; and a display panel and a projection lens group, the display panel being located at a front focal plane of the projection lens group. The coupling-in refractive/reflective element refracts/reflects the forward incident light to increase the angle between the incident light entering the coupling-in volume holographic optical element and the normal direction of the waveguide plate, thereby reducing the Bragg wavelength degeneracy effect of the diffracted light to increase usable viewing angle.

### BACKGROUND OF THE INVENTION

### Fields of the Invention

The present invention relates to a volumetric holographic optical waveguide element for a mixed reality near-eye display.

### Descriptions of Related Art

The basic architecture of applying a light-guide optical element manufactured with holographic gratings to augmented reality/mixed reality (AR/MR) glasses is shown in FIG. 1. In the light machine on the right, the micro-panel is usually placed at the front focal plane of the projection lens, so that the point light sources of different pixels of the image will be converted into plane light waves of different incident angles, and projected onto the holographic optical coupling-in element HOE1 to generate diffraction. Plane light waves of different angles are coupled into the flat light guide and transmitted to the observer's eyes on the left at total reflection angle. Then, another holographic grating in a mirror form is used in the holographic optical coupling-out element HOE2 to guide the information light into the human's eyes. This technology can effectively reduce the weight and volume of the display system because the light guide itself is thin and light, and the current technology can produce high-resolution (>6000 ppi) micro-panels to form small-sized light machines. Therefore, it is very suitable for use in head-mounted displays or glasses-type displays.

More mature existing products generally use thin holographic optical elements (THOE) with smaller thickness to achieve the purpose of diffractive light guidance. However, due to grating diffraction efficiency and dispersion, it is challenged in achieving both high efficiency and wide-view full-color light guidance. Volume holographic optical elements (VHOE) with increased thickness and high diffraction efficiency are common alternates to increase light guide efficiency. However, volume gratings have strict Bragg diffraction conditions, and the wavelength shift tolerance and angle shift tolerance that can cause effective diffraction are very small. Therefore, the common advancement involves the utilization of micro projectors with broadband LEDs as light sources. However, such improvement methods are limited, and the bandwidth of the LED light source is still not adequate to offer a sufficiently wide viewing angle.

### SUMMARY OF THE INVENTION

When the present invention is actually applied to near-eye and head-up displays, its field of view can be 1.5 times larger than that of the conventional technology.

In order to achieve the above objectives and effects, the present invention provides a volumetric holographic optical waveguide element for a mixed reality near-eye display, comprising: a waveguide plate; a coupling-in element group, which includes a coupling-in volume holographic optical element and a coupling-in refractive element disposed on both corresponding sides of the waveguide plate, respectively; an coupling-out element group, which includes an coupling-out volume holographic optical element and a coupling-out refractive element disposed on both corresponding sides of the waveguide plate, respectively; and a display panel and a projection lens group, the projection lens group being located between the display panel and the waveguide plate, and the display panel being located at a front focal plane of the projection lens group. The coupling-in volume holographic optical element and the coupling-out volume holographic optical element are located on the same side of the waveguide plate. The coupling-in refractive element and the coupling-out refractive element are located on the same side of the waveguide plate.

The present invention further provides another volumetric holographic optical waveguide element for a mixed reality near-eye display, comprising: a waveguide plate; a coupling-in element group, which includes a coupling-in volume holographic optical element and a coupling-in reflective element disposed on both corresponding sides of the waveguide plate, respectively; a coupling-out element group, which includes an coupling-out volume holographic optical element and a coupling-out refractive element disposed on both corresponding sides of the waveguide plate, respectively; and a display panel and a projection lens group, the projection lens group being located between the display panel and the waveguide plate, and the display panel being located at a front focal plane of the projection lens group. The coupling-in volume holographic optical element and the coupling-out volume holographic optical element are located on different sides of the waveguide plate. The coupling-in reflective element and the coupling-out refractive element are located on different sides of the waveguide plate.

### BRIEF DESCRIPTION OF THE DRAWINGS

FIG. 1 is a schematic diagram of a conventional VHOE architecture.

FIG. 2a is a schematic diagram for illustrating the color shift produced when the full-color image is superimposed at the output end.

FIG. 2b is a schematic diagram for illustrating the color shift produced when the full-color image is superimposed at the output end.

FIG. 3 shows the slope of the inclined curve.

FIG. 4 is a schematic diagram for illustrating the relationship among the structure of the volume grating, the reading light and the diffracted light.

FIG. 5 is a simplified schematic diagram of the architecture of FIG. 4.

FIG. 6 is a schematic diagram of the architecture according to a first embodiment of the present invention.

FIG. 7 is a simplified schematic diagram of the architecture of FIG. 6.

FIG. 8 is a schematic diagram of the architecture according to a second embodiment of the present invention.

FIG. 9 is a simplified schematic diagram of the architecture of FIG. 8.

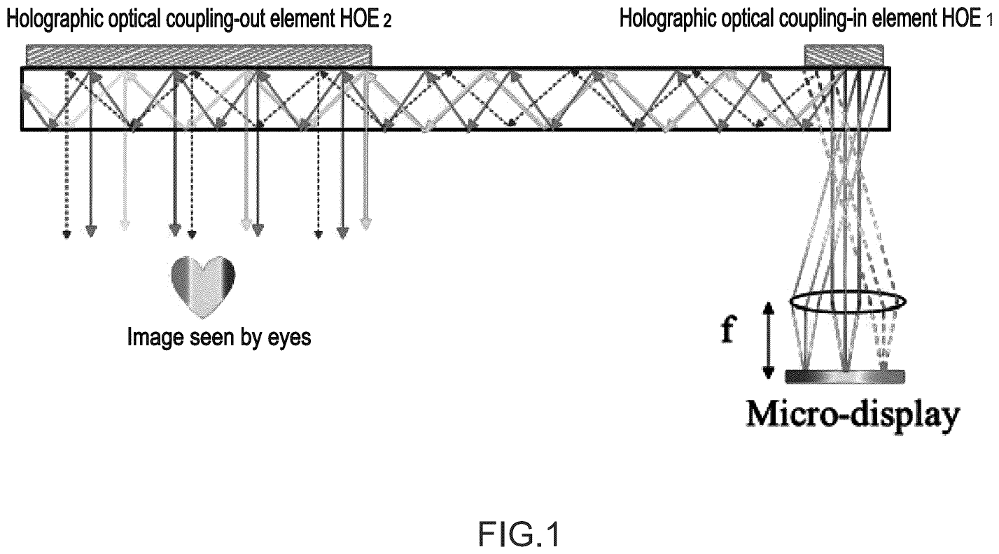

### DETAILED DESCRIPTION OF THE PREFERRED EMBODIMENT

The implementation principle of the present invention will be described in detail below. The LED light sources of a variety of projectors have different band distribution ranges. Therefore, there is interdependent relationship among the bandwidth of the light source, the angular multiplexing number, and the achievable FOV range. However, multiplexing or multiple layers will increase the complexity of production and design.

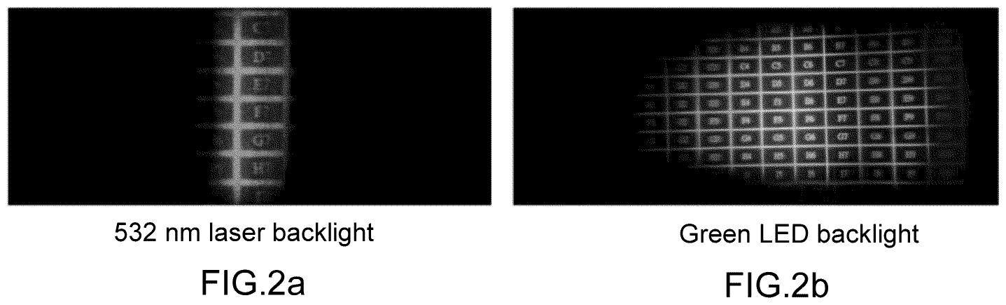

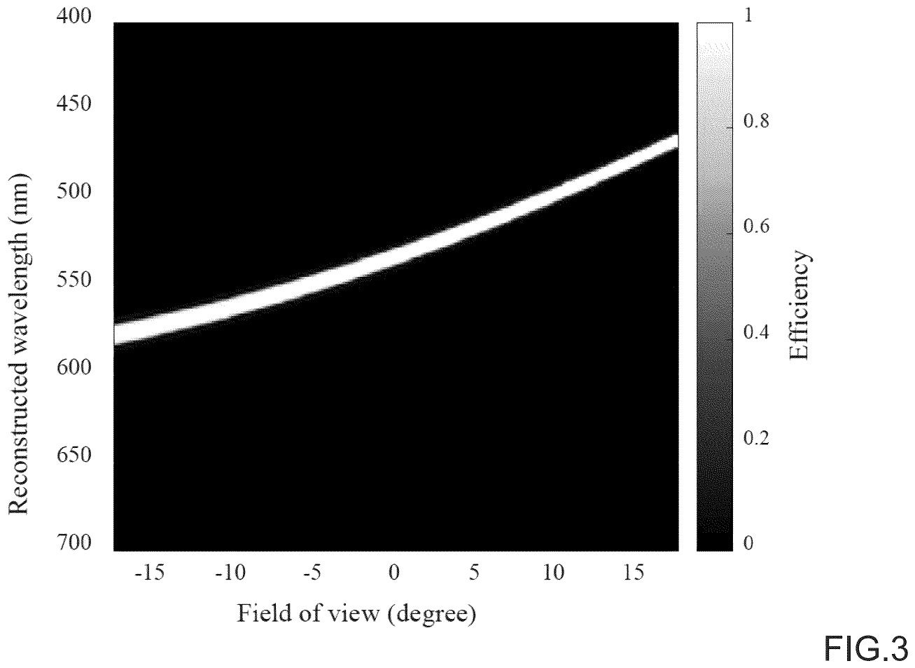

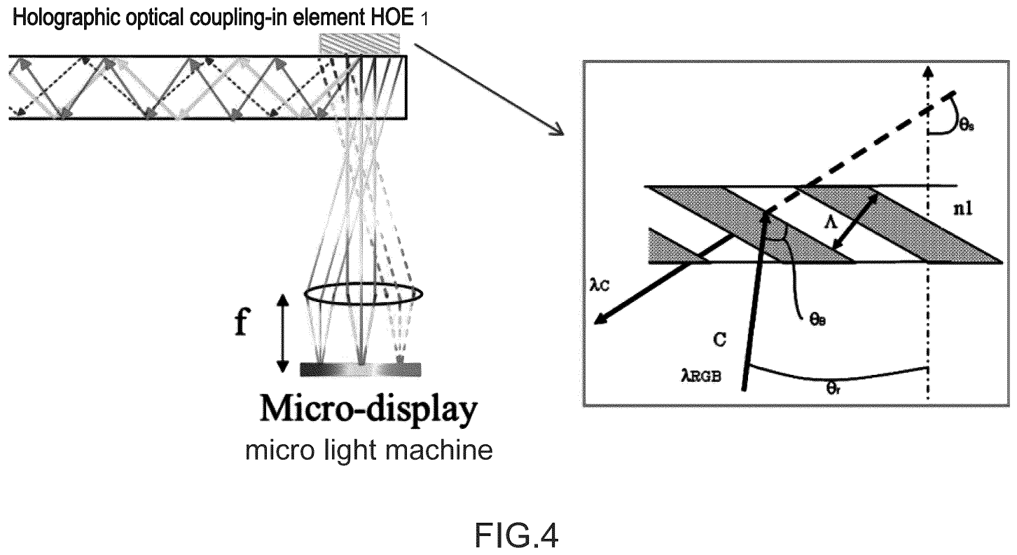

In addition, the light guide characteristics of VHOE result in a very small viewing angle due to the Bragg diffraction characteristics at a single wavelength, as shown in FIG. 2a. Instead, using a broadband LED as the light source can increase the viewing angle, but causes serious color shift in superimposing full-color images at the output end. As shown in FIG. 2b, the image at 10 degrees on the far right corresponds to the Bragg degeneracy range of the bluish light band, so the image is bluish. To address both issues of maintaining a wide field of view and minimizing chromatic aberration, it is essential to consider the fundamental principle of Bragg degeneracy inherent in volume holographic wavelengths. Based on theoretical considerations, the slope, δλ_{c}/δθ_{B}, of the inclined curve in FIG. 3 should be adjusted. A flatter slope indicates a wider field of view along the horizontal axis for the same bandwidth of the LED light source. Additionally, it reduces the wavelength difference of the drift observed in the peripheral pixels of the display. That is, the chromatic aberration can also be relatively reduced. The calculation of δλ_{c}/δθ_{B} can be explained with reference to FIG. 4, which shows the relationship among the structure of a single volume grating, the reading light and the diffracted light. Here, θs is the angle of diffracted light, θᵣ is the angle of the reading light, θ_{B} is the Bragg angle of the grating, and Λ is the grating period.

In the design of the volume hologram depicted in the above figure, the light wave is recorded based on the central wavelength (λ_{C} in the figure) emitted from the central pixel. Therefore, after the recording is completed, the Bragg condition of grating diffraction is:

$${λ}_{c} = 2 {n}_{1} Λ sin {θ}_{B} and {θ}_{B} = ( {θ}_{s} - {θ}_{r} ) / 2$$

In other words, after the recording is completed, the plane light wave with a wavelength of λ_{C} emitted from the central pixel will produce a diffracted light wave that meets the Bragg condition. Generally, its diffraction efficiency is the highest. If the reading pixels move to both sides of the micro-display panel, due to the factor of the projection lens, the reading light is increased by an inclination angle δθB. This causes the originally recorded volume holographic grating to be read by a plane light wave incident at the angle of θB±δθB. According to the relationship of the above formula, if the light wavelength still maintains λ_{C}, the Bragg condition will not be satisfied, resulting in a reduction in diffraction efficiency, which limits the field of view. If high-efficiency Bragg diffraction is desired to expand the field of view, it is necessary for the reading wavelength to change δλc to satisfy the Bragg degeneracy condition. Accordingly, this technology to expand the field of view is called the wavelength Bragg degeneracy technology. The relationship between δλc and δθB, i.e. the slope, δλc/δθB, of the inclined curve in FIG. 3, can be represented by the following formula derived from the differential of the above formula:

$$δ {λ}_{c} / δ {θ}_{B} = 2 {n}_{1} Λ cos {θ}_{B} = 2 {n}_{1} cos {θ}_{B} \frac{{λ}_{c}}{2 {n}_{1} sin {θ}_{B}} = \frac{{λ}_{c}}{tan {θ}_{B}}$$

It can be seen from the above formula that the most efficient way to reduce the slope, δλc/δθB, of the curve is to increase the Bragg angle θ_{B} of the originally recorded volume hologram grating, meaning increase in the angle difference (θs−θr). However, the operating principle of the holographic grating light guide element indicates that the angle θs of the diffracted light must satisfy the total reflection relationship for light transmission and thus cannot be changed. Additionally, the arrangement of the micro light machine is required to allow incident light into the waveguide element from the front side to accommodate the structure of the glasses. Otherwise, the temples would become too bulky and difficult to wear.

To this end, the present invention mainly adds a refractive or reflective element to pre-adjust the angle of the diffracted light without changing the arrangement of the light machine and the holographic optical coupling-in element HOE1, resulting in increased angle difference (θs−θr).

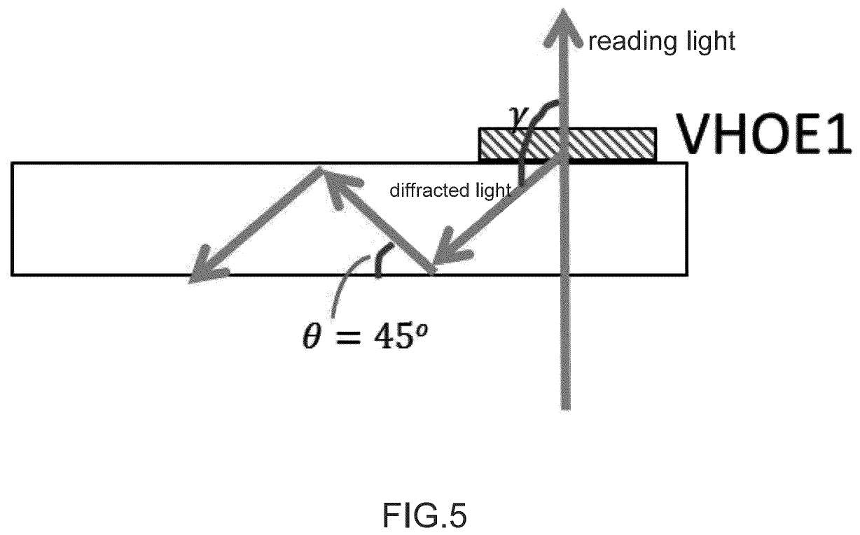

First, the structure diagram of FIG. 4 is simplified into the schematic diagram of FIG. 5 to facilitate the theoretical calculation of the slope δλc/δθB of the curve as follows. In the traditional structure, the arrangement of the micro light machine allows the reading light is front incident, i.e. θr=0, and the diffracted light must meet the condition of total reflection in the waveguide plate. In the assumption of its refractive index being n=1.5, the angle θ in the figure needs to be greater than 43 degrees. Then, the angle is approximated to 45° (θs=45°) for calculation, followed by introducing θB=(θs−θr)/2=67.5° into the above formula to obtain as follows:

$$\frac{δ {λ}_{c}}{δ {θ}_{B}} = \frac{{λ}_{c}}{tan {θ}_{B}} = 0.41 {λ}_{c}$$

Compared with the above examples, the present invention theoretically demonstrates that two structural embodiments can be used for design and estimation.

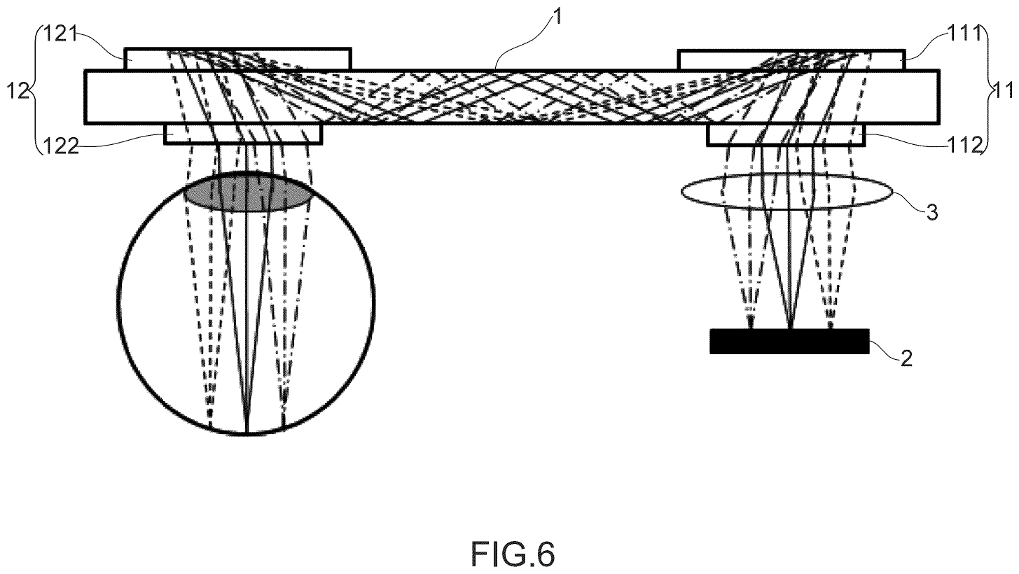

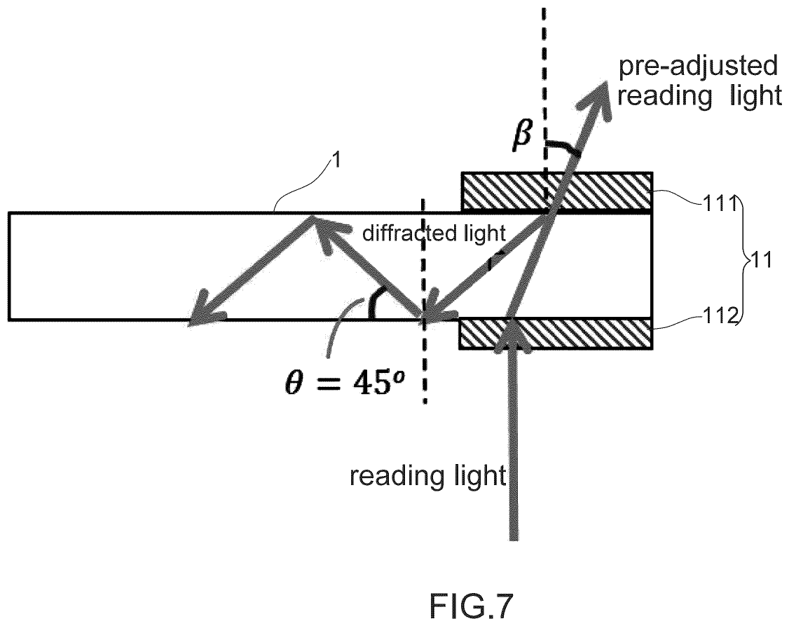

In the first embodiment, as shown in FIG. 6, a volumetric holographic optical waveguide element for a mixed reality near-eye display comprises: a waveguide plate 1; a coupling-in element group 11, which includes a coupling-in volume holographic optical element 111 and a coupling-in refractive element 112 disposed on both corresponding sides of the waveguide plate 1, respectively; an coupling-out element group 12, which includes an coupling-out volume holographic optical element 121 and a coupling-out refractive element 122 disposed on both corresponding sides of the waveguide plate 1, respectively. The coupling-in refractive element 112 refracts the forward incident light, causing it to skew and increasing the angle between the incident light entering the coupling-in volume holographic optical element 111 and the normal direction of the waveguide plate 1. This enhances the Bragg wavelength degeneracy effect of the diffracted light. The coupling-out refractive element 122 refracts the skewed light diffracted from the coupling-out volume holographic optical element 121 back towards the normal direction, enabling its forward exit from the waveguide plate 1. This process reduces image distortion and facilitates clearer observation. The volume holographic optical waveguide element and the light machine constitute a mixed reality near-eye display. The light machine contains a display panel 2 and a projection lens group 3. The projection lens group 3 is located between the display panel 2 and the waveguide plate 1. The display panel 2 is located at the front focal plane of the projection lens group 3. The coupling-in volume holographic optical element 111 and the coupling-out volume holographic optical element 121 are located on the same side of the waveguide plate 1. The coupling-in refractive element 112 and the coupling-out refractive element 122 are located on the same side of the waveguide plate 1. The right side of the structure in this embodiment can be simplified as shown in FIG. 7. The coupling-in refractive element 121 is added on the other side of the waveguide plate 1 to refract the forward incident reading light emitted from the light machine to the pre-adjusted direction.

In one embodiment of the present disclosure, the coupling-in volume holographic optical element 111 of the coupling-in element group 11 is based on a volumetric holographic grating formed by the interference recording of the plane wave in the skewed light direction and the plane wave in propagation direction of the total reflection within the waveguide plate 1.

In one embodiment of the present disclosure, the coupling-out volume holographic optical element 121 of the coupling-out element group 12 is based on a volumetric holographic grating formed by the interference recording of the plane wave in the opposite direction of the total reflection light propagation within the waveguide plate 1 and the plane wave in the skewed light direction.

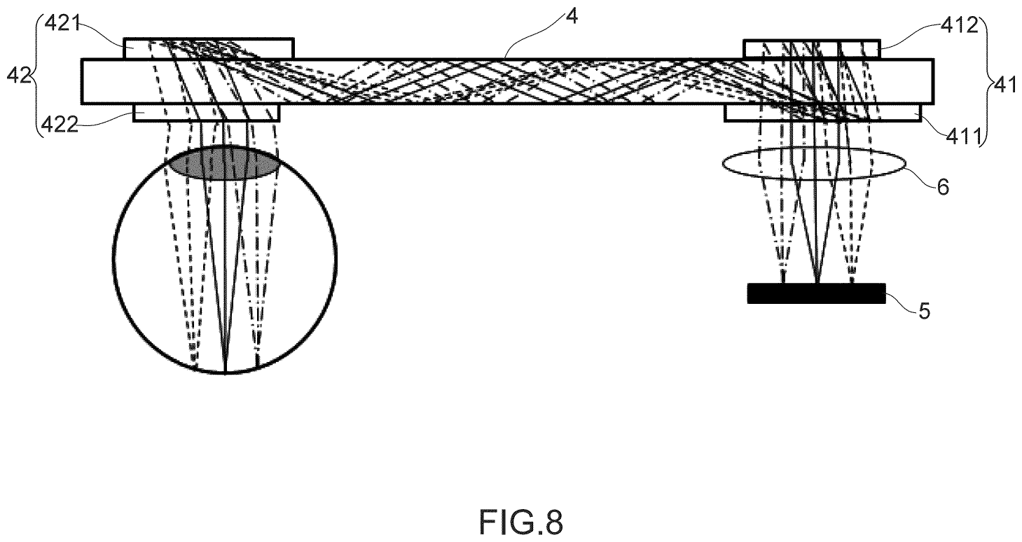

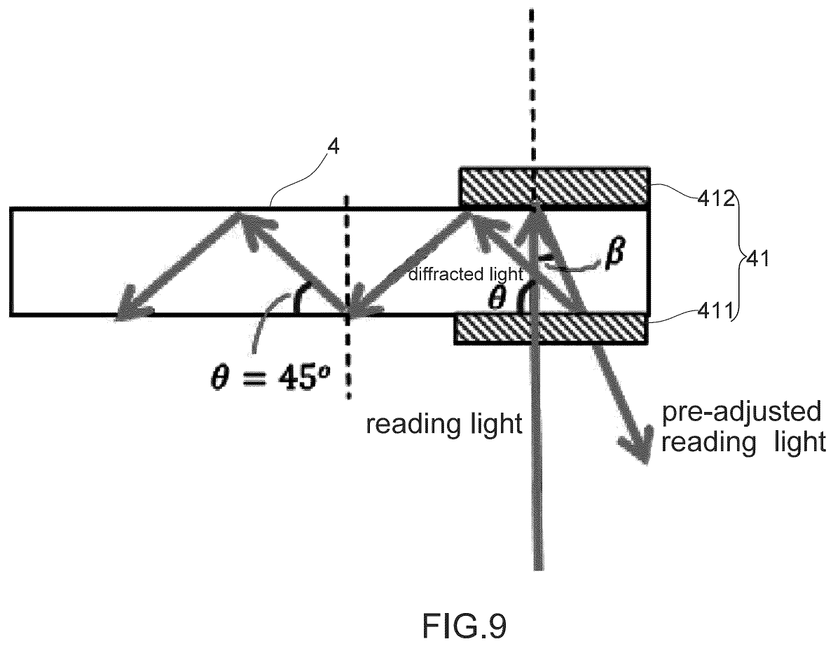

The second embodiment provides a volumetric holographic optical waveguide element for a mixed reality near-eye display as shown in FIG. 8, which comprises: a waveguide plate 4; a coupling-in element group 41, which includes a coupling-in volume holographic optical element 411 and a coupling-in reflective element 412 disposed on both corresponding sides of the waveguide plate 4, respectively; a coupling-out element group 42, which includes an coupling-out volume holographic optical element 421 and a coupling-out refractive element 422 disposed on both corresponding sides of the waveguide plate 4, respectively. The coupling-in reflective element 412 reflects the forward incident light, causing it to skew and increasing the angle between the incident light entering the coupling-in volume holographic optical element 411 and the normal direction of the waveguide plate 4. This enhances the Bragg wavelength degeneracy effect of the diffracted light. The coupling-out refractive element 422 refracts the skewed light diffracted from the coupling-out volume holographic optical element 421 back towards the normal direction, enabling its forward exit from the waveguide plate 4. This process reduces image distortion and facilitates observation. The volume holographic optical waveguide element and the light machine constitute a mixed reality near-eye display. The light machine contains a display panel 5 and a projection lens group 6. The projection lens group 6 is located between the display panel 5 and the waveguide plate 1. The display panel 5 is located at the front focal plane of the projection lens group 6. The coupling-in volume holographic optical element 411 and the coupling-out volume holographic optical element 421 are located on different sides of the waveguide plate 4. The coupling-in reflective element 412 and the coupling-out refractive element 422 are located on different sides of the waveguide plate 4. The right side of the structure in this embodiment can be simplified as shown in FIG. 9. The reading light is reflected by the coupling-in reflective element 412 to the adjusted direction for the reading light. Then, the adjusted reading light is radiated into the coupling-in volume holographic optical element 411 to couple the light wave into the waveguide plate 4.

The formation method of the coupling-in volume holographic optical element 411 and the coupling-out volume holographic optical element 421 in this embodiment is the same as that in the aforementioned embodiment.

Both of the above embodiments increase the angles of the adjusted reading light and the original diffracted light by an angle value of β. In the assumption of β=15°, the adjusted θ_{B}=(θₛ−θᵣ+β)/2=75° is introduced into the previous formula to obtain as follows:

$$\frac{δ {λ}_{c}}{δ {θ}_{B}} = \frac{{λ}_{c}}{tan {θ}_{B}} = 0.2 \; 68 {λ}_{c}$$

The slope, δλ_{c}/δθ_{B}, of the curve is significantly reduced by about 1.5 times. In other words, for the LED band spectrum of the projector light source with the same bandwidth, the field angle of view for the two embodiments of the present invention can be 1.5 times larger than the conventional technology. Additionally, due to the reduced slope, the wavelength drift can also be reduced by 14% within the same viewing angle, thereby reducing chromatic aberration. This is very important and critical advancement for promoting VHOE as the architecture of AR/MR glasses.

What is claimed is:

1. A volumetric holographic optical waveguide element for a mixed reality near-eye display, comprising:
a waveguide plate;
a coupling-in element group, which includes a coupling-in volume holographic optical element and a coupling-in refractive element disposed on both corresponding sides of the waveguide plate, respectively;
an coupling-out element group, which includes an coupling-out volume holographic optical element and a coupling-out refractive element disposed on both corresponding sides of the waveguide plate, respectively; and
a display panel and a projection lens group, the projection lens group being located between the display panel and the waveguide plate, and the display panel being located at a front focal plane of the projection lens group;
wherein the coupling-in volume holographic optical element and the coupling-out volume holographic optical element are located on the same side of the waveguide plate, and the coupling-in refractive element and the coupling-out refractive element are located on the same side of the waveguide plate.

2. The volumetric holographic optical waveguide element for a mixed reality near-eye display as claimed in claim 1, wherein the waveguide plate is one of a glass or transparent polymer substrate with high refractive index.

3. The volumetric holographic optical waveguide element for a mixed reality near-eye display as claimed in claim 1, wherein writing of the coupled-in volume holographic optical element and writing of the coupled-out volume holographic optical element are based on volume holographic grating formed by interference recording of a plane wave in skewed light direction and a plane wave in propagation direction of total reflection in the waveguide plate, and both of the plane waves being arranged in a mirror relationship during the writing.

4. A volumetric holographic optical waveguide element for a mixed reality near-eye display, comprising:
a waveguide plate;
a coupling-in element group, which includes a coupling-in volume holographic optical element and a coupling-in reflective element disposed on both corresponding sides of the waveguide plate, respectively;
a coupling-out element group, which includes an coupling-out volume holographic optical element and a coupling-out refractive element disposed on both corresponding sides of the waveguide plate, respectively; and
a display panel and a projection lens group, the projection lens group being located between the display panel and the waveguide plate, and the display panel being located at a front focal plane of the projection lens group;
wherein the coupling-in volume holographic optical element and the coupling-out volume holographic optical element are located on different sides of the waveguide plate, and the coupling-in reflective element and the coupling-out refractive element are located on different sides of the waveguide plate.

5. The volumetric holographic optical waveguide element for a mixed reality near-eye display as claimed in claim 4, wherein the waveguide plate is one of a glass or transparent polymer substrate with high refractive index.

6. The volumetric holographic optical waveguide element for a mixed reality near-eye display as claimed in claim 4, wherein writing of the coupled-in volume holographic optical element and writing of the coupled-out volume holographic optical element are based on volume holographic grating formed by interference recording of a plane wave in skewed light direction and a plane wave in propagation direction of total reflection in the waveguide plate, and both of the plane waves being arranged in a mirror relationship during the writing.
